(19) United States
(12) Patent Application Publication
(10) Pub. No.: US 2014/0160574 A1
(43) Pub. Date: Jun. 12, 2014

(54) OPTICAL SHEET, BACKLIGHT UNIT INCLUDING THE SAME, AND DISPLAY APPARATUS INCLUDING THE SAME

(71) Applicant: Cheil Industries Inc., Gumi-si (KR)

(72) Inventors: Young Hyun Ju, Uiwang-si (KR); Kalantar Kalil, Uiwang-si (KR); Seung Man Choi, Uiwang-si (KR)

(73) Assignee: CHEIL INDUSTRIES INC., Gumi-si (KR)

(21) Appl. No.: 14/099,894

(22) Filed: Dec. 6, 2013

(30) Foreign Application Priority Data
Dec. 7, 2012 (KR) 10-2012-0142299

(51) Int. Cl. G02B 5/04

(52) U.S. Cl. CPC G02B 5/045
USPC 359/625

(57) ABSTRACT

An optical sheet includes: a base film comprising a rear surface upon which light is incident, a front surface facing the rear surface for emitting the light, and a side surface connecting the rear and front surfaces to each other; and a light collection section in which prisms formed by coupling a plurality of prism units to each other are arranged on the front surface of the base film and integrated with the base film. One end surface of each prism unit has a semicircular shape. A backlight unit includes the optical sheet, and an optical apparatus includes the backlight unit or the optical sheet.

### CROSS REFERENCE TO RELATED APPLICATION

This application claims priority to and the benefit of Korean Patent Application No. 10-2012-0142299, filed on Dec. 7, 2012, the entire content of which is incorporated herein by reference.

### BACKGROUND

1. Technical Field

Embodiments of the present invention relate to an optical sheet, a backlight unit including the same, and a display apparatus including the same. More particularly, embodiments of the present invention relate to an optical sheet that includes a prism formed by coupling prism units, each of which includes a prism having a triangular cross-section and a lenticular film having a semicircular cross-section.

2. Description of the Related Art

Currently, backlight units, including large TVs, include a diffusive sheet, a prism sheet, a protective sheet, and the like. Generally, the backlight unit has a structure in which the prism sheet and the protective sheet are sequentially stacked on the diffusive sheet. Light emitted from a light guide plate diffuses through the diffusive sheet, and the diffused light is incident upon the prism sheet, thereby providing high brightness through condensation. The protective sheet serves to protect the surface shapes of the prism sheet.

The prism sheet is a sheet in which prisms having a triangular cross-section are arranged. Despite having improved brightness, the prism sheet typically has a narrow viewing angle. To overcome such a narrow viewing angle, a lenticular film may be used. However, while the lenticular film has a wide viewing angle, it also has low brightness. Although the lenticular film can provide wider viewing angles than the prism film, the lenticular film exhibits low brightness at its center (i.e., low brightness when the backlight unit is viewed from the front).

### SUMMARY

In accordance with embodiments of the present invention, an optical sheet includes a base film including a rear surface upon which light is incident, a front surface facing the rear surface for emitting the light, and a side surface connecting the rear and front surfaces to each other. The optical sheet also includes a light collection section, in which prisms (formed by coupling a plurality of prism units to each other) are arranged on the front surface of the base film and integrated with the base film. When one end surface of each prism unit is defined as a first surface and the other end surface is defined as a second surface in a longitudinal direction, the first or second surface has a semicircular shape.

In accordance with other embodiments of the present invention, a backlight unit includes the optical sheet.

In accordance with further embodiments of the present invention, an optical apparatus includes the optical sheet.

### BRIEF DESCRIPTION OF THE DRAWINGS

These and other features and advantages of embodiments of the present invention will be better understood by reference to the following detailed description when considered in conjunction with the accompanying drawings, in which:

FIG. 1 is a perspective view of a prism unit according to one embodiment of the present invention;

FIG. 2 is a perspective view of a prism unit according to another embodiment of the present invention;

FIG. 3 is a perspective view of a prism unit according to a further embodiment of the present invention;

FIG. 4 is a conceptual diagram showing a first surface and a second surface in a prism unit according to embodiments of the present invention;

FIG. 5 is a conceptual diagram showing a side surface of a prism unit according to embodiments of the present invention;

FIG. 6 is a perspective view of an optical sheet according to one embodiment of the present invention;

FIG. 7 is a perspective view of a prism according to an embodiment of the present invention;

FIG. 8 is a perspective view of a prism according to another embodiment of the present invention;

FIG. 9 is a plan view of an optical sheet according to another embodiment of the present invention;

FIG. 10 is a perspective view of a prism according to a further embodiment of the present invention;

FIG. 11 is a simulation diagram;

FIGS. 12(a) to 12(c) are end views of the prisms of Comparative Examples 1 to 3, respectively;

FIG. 13 is a set of graphs of the simulation results for the optical sheets of Examples 1 to 3;

FIG. 14 is a set of graphs of the simulation results of the optical sheets of Examples 4 to 6; and

FIG. 15 is a set of graphs of the simulation results of the optical sheets of Comparative Examples 1 to 3.

### DETAILED DESCRIPTION

As used herein, the term ‘prism unit’ may mean a unit body forming a prism. The prism unit may be coupled to another prism unit in at least one of a pitch direction or a longitudinal direction to form a prism.

In accordance with embodiments of the present invention, an optical sheet may include a prism unit in which a prism having a triangular cross-section and a lenticular film having a semicircular cross-section are combined into a single structure.

When one end surface of the prism unit is defined as a first surface, and the other end surface of the prism unit (in a longitudinal direction) is defined as a second surface of the prism unit, at least one of the first and second surfaces may have a semicircular shape.

In one embodiment, the first surface may have a triangular shape, and the second surface may have a semicircular shape.

In another embodiment, the first surface may have a semicircular shape, and the second surface may have a triangular shape.

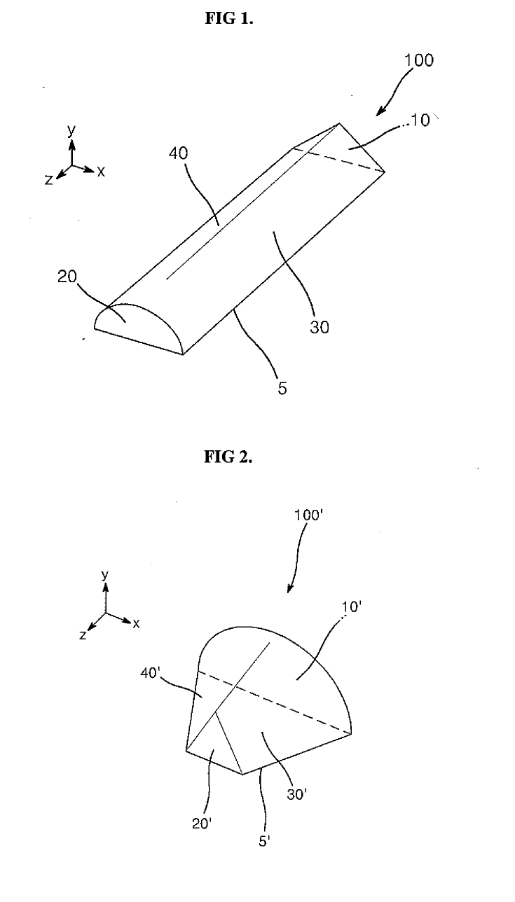

In one embodiment, the prism unit may have a constant height, pitch and apex angle in the longitudinal direction. FIG. 1 is a perspective view of a prism unit having a constant height, pitch and apex angle according to one embodiment of the invention.

Referring to FIG. 1, a prism unit 100 may include: a rear surface 5; opposite end surfaces 10, 20, i.e., opposite to each other in the longitudinal direction of the prism unit (z-direction); and side surfaces 30, 40 connecting the opposite end surfaces to each other. For convenience, the opposite end surfaces are defined as a first surface 10 and a second surface 20. The designations of first and second surfaces are interchangeable.

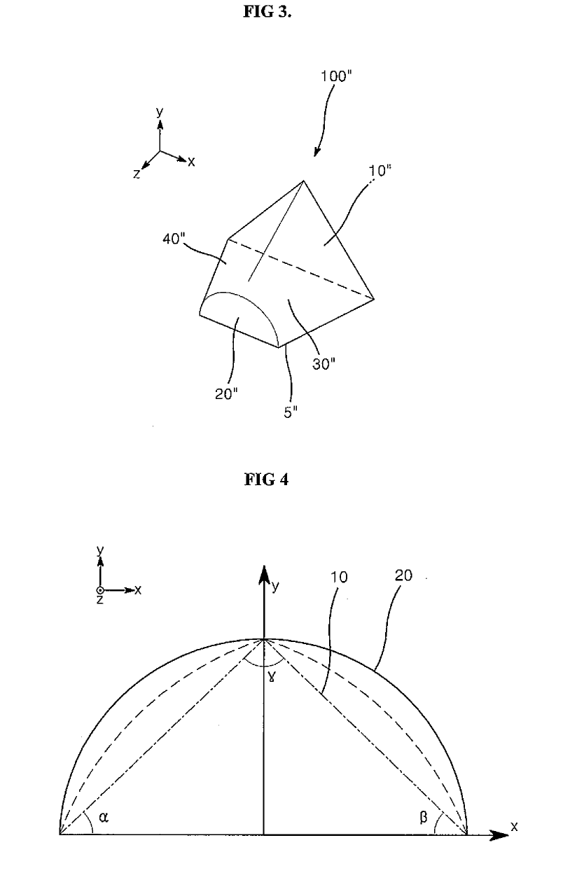

In another embodiment, at least one of a height, a pitch and an apex angle of the prism unit may vary in the longitudinal direction. FIGS. 2 and 3 show prism units, each of which has a varying height and a varying pitch. The varying pitch of the prism unit may reduce the Moire phenomenon, and the varying height of the prism unit may prevent excessively close contact between the prism units.

The prism unit may have an increasing or decreasing pitch, height, or apex angle in the longitudinal direction (z-direction).

Referring to FIG. 2, a prism unit 100′ may include: a rear surface 5′; opposite end surfaces 10′, 20′ (opposite to each other in the longitudinal direction); and side surfaces 30′, 40′ connecting the opposite end surfaces to each other.

Referring to FIG. 3, a prism unit 100″ may include: a rear surface 5″; opposite end surfaces 10″, 20″ (opposite to each other in the longitudinal direction); and side surfaces 30″, 40″ connecting the opposite end surfaces to each other.

The rear surface is an incident surface upon which light having passed through a base film of an optical sheet (described below) is incident, and the incident light may be emitted through the prism.

The first and second surfaces 10, 20 face each other, and are connected to each other by the side surfaces 30, 40. The first surface 10 may have a triangular shape (as in typical prisms), and the second surface 20 may have a semicircular shape.

When the pitch, height and longitudinal directions of the prism unit are respectively represented by x, y and z, the prism unit may have a cross-section that changes from a triangular shape to a semicircular shape (or vice versa) in the z-direction. Thus, when included in an optical sheet, the prism unit may allow the optical sheet to exhibit improved brightness while also having a wide viewing angle.

FIG. 4 is a conceptual diagram of a first surface and a second surface in the prism unit of FIG. 1. Referring to FIG. 4, a prism has a cross-section that gradually changes from a triangular shape to a semicircular shape with increasing distance from the first surface 10 to the second surface 20 of the prism of FIG. 1. In FIG. 4, the dash-dotted line denotes the first surface 10, the solid line denotes the second surface 20, and the dotted line between the dash-dotted line and the solid line denotes the cross-section of the prism unit that changes from the first surface to the second surface. As such, according to embodiments of the invention, the side surfaces of the prism unit are curved in order to connect the first and second surfaces which have different shapes.

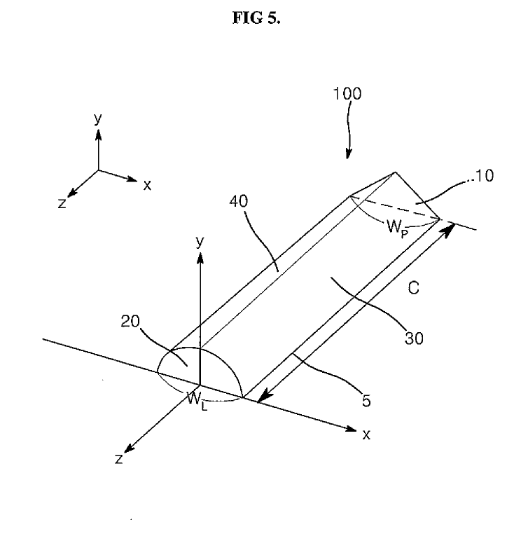

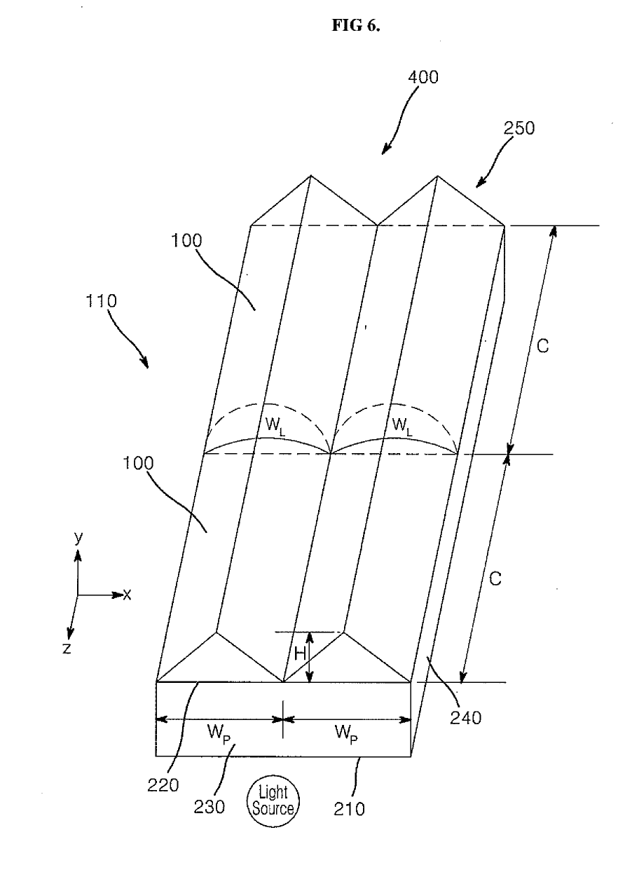

FIG. 5 is a conceptual diagram of the side surface of a prism unit according to embodiments of the present invention. Referring to FIG. 5, the side surfaces of the prism unit may have a radius of curvature R, which can be calculated using Equation 1.

$$R = P \times {z}^{2} + \frac{( K - P )}{{C}^{3}} \qquad Equation 1$$

In Equation 1, P is the value of half the pitch (W_{P} or W_{L} of the first or second surface, z is the value of the z-component of the coordinates (x, y, z) of the prism unit (where the pitch, height and longitudinal directions of the prism unit are represented by x, y and z, respectively), K is a constant from 100 to 10,000, and C is the length of the prism.

In some embodiments, the side surfaces of the prism unit may have a radius of curvature R of about 1 μm to about 100,000 μm. The prism has a semicircular cross-section as K approaches 100, and has a triangular cross-section as K approaches 10,000.

The prism unit according to embodiments of the invention will be described with reference to FIGS. 4 and 5. For convenience, the pitch, height and longitudinal directions of the prism unit are defined as x, y and z, respectively. According to FIG. 5, the value of the z-component of the coordinates is determined at a specific position in the z-direction. The value of the z-component, the length C of the prism, the value of half the pitch (W_{P} or W_{L}), and the value of K are substituted into Equation 1, thereby calculating the radius of curvature R. The constant a is calculated using Equation 2 (below) based on the radius of curvature R. The value of the y-component of the coordinates is calculated based on the value of the corresponding x-component. In particular, the y-component is calculated using Equation 3 when the value of the x-component is 0 or less, or using Equation 4 when the value of the x-component is greater than 0. The side surface of the prism unit is obtained by combining the coordinates (x, y, z) determined by the values of x, y and z, calculated as described above.

$$a = \frac{- 2 P + \sqrt{{P}^{2} - 8 ( {P}^{2} - {R}^{2} )}}{4} \qquad Equation 2$$

In Equation 2, P is the value of half the pitch (W_{P} or W_{L}) of the first or second surface, and R is the radius of curvature calculated using Equation 1.

y=\sqrt{R²−(x−a)²}−a Equation 3

In Equation 3, a is the constant calculated using Equation 2, and R is the radius of curvature calculated using Equation 1.

y=\sqrt{R²−(x+a)²}−a Equation 4

In Equation 4, a is the constant calculated using Equation 2, and R is the radius of curvature calculated using Equation 1.

The prism unit forms a light collection section in the optical sheet and allows the optical sheet to have a wide viewing angle as well as exhibit improved brightness compared with conventional prism sheets.

A higher index of refraction of the prism unit is more advantageous for the prism unit. The prism unit may have an index of refraction from about 1.40 to about 1.70, but is not limited thereto. Within this range, the optical sheet can exhibit improved light collection and viewing angle.

The prism unit may have a pitch W_{P} or W_{L} of about 1 μm to about 50,000 μm, for example about 1 μm to about 500 μm. The prism unit may have a height H of about 1 μm to about 50,000 μm, for example about 1 μm to about 500 μm. The prism unit may have a length C of about 1 μm to about 500,000 μm, for example about 1 μm to about 500 μm. Within any one of these ranges, the optical sheet can exhibit improved brightness and viewing angle.

When the prism unit has a triangular cross-section, the prism unit may have a base angle α of about 30° to about 60°, an angle β facing the base angle α of about 30° to about 60°, and an apex angle γ (represented by 180−(α+β)°) of about 60° to about 120°. Within any one of these ranges, the optical sheet can exhibit improved brightness and viewing angle. The apex angle refers to the angle facing the rear surface of the prism unit.

Each prism may include at least two prism units coupled to each other in the longitudinal direction. Coupling of the prism units may be accomplished by coupling the first surfaces of the prism units to each other, or by coupling the second surfaces of the prism units to each other. The prisms may be continuously arranged in at least one of the pitch direction or the longitudinal direction.

In the optical sheet according to embodiments of the invention, the prism may form a light collection section.

FIG. 6 is a perspective view of an optical sheet according to one embodiment of the present invention. Referring to FIG. 6, an optical sheet 400 according to an embodiment may include a base film 240 and a light collection section 250. The base film 240 includes a rear surface 210, a front surface 220 facing the rear surface, and a side surface 230 connecting the rear and front surfaces to each other. The light collection section 250 includes prisms 110 formed by coupling a plurality of prism units 100, and the prisms 110 are arranged on the front surface of the base film and are integrated with the base film.

The optical sheet may be disposed between a diffusive film and a protective film, but the present invention is not limited thereto. The diffusive film diffuses light emitted from a light guide plate in a display apparatus. The protective film protects the shape of the prism sheet. As a result, the optical sheet can collect light passing through the diffusive film, and thus can replace existing prism sheets.

The rear surface is the surface upon which light emitted from a light source and passing through the light guide plate is incident, and the front surface is the surface from which light having passed through the rear surface is emitted. Light having passed through the rear surface is collected by the light collection section formed on the front surface, and is then emitted.

The prisms (formed by coupling the plurality of prism units to each other) are arranged on the front surface of the base film and are integrated with the base film. The prisms form the light collection section, which collects light passing through the rear surface.

The prism units may be disposed in any arrangement on the front surface of the base film without limitation. For example, the prism units may be randomly arranged. At least two prism units coupled to each other in the longitudinal direction may be arranged on the front surface of the base film.

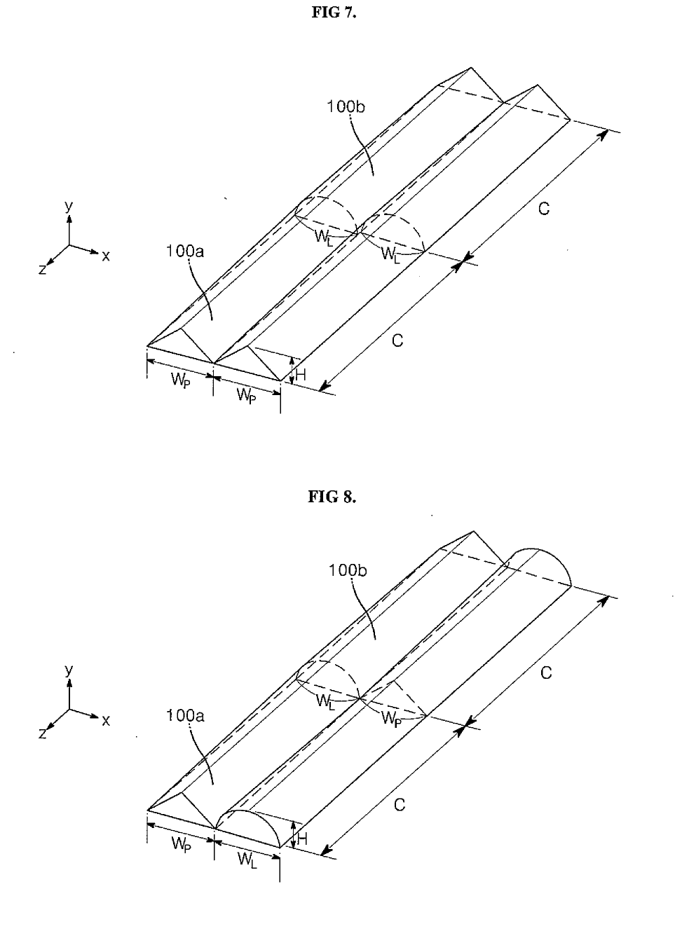

FIGS. 7, 8 and 10 show exemplary arrangements of the prism units.

FIGS. 7 and 8 illustrate a prism in which two prism units (shown in FIG. 1) are coupled to each other in the longitudinal direction. However, it should be understood that the present invention is not limited thereto. For example, at least two prism units may be coupled to each other in the pitch direction.

The prism may have a structure in which the cross-section of the prism gradually changes from a triangular shape into a semicircular shape, and gradually changes back from a semicircular shape into a triangular shape in the longitudinal direction. It should be understood that the present invention is not limited thereto. That is, the cross-section of the prism may gradually change from a semicircular shape into a triangular shape and gradually change back from a triangular shape into a semicircular shape in the longitudinal direction. In addition, the prism may have a structure in which such gradual changes are repeated several times.

At least one of the height, pitch and apex angle of the prism may be constant or may vary.

The prisms may be continuously arranged in the pitch direction of the prism unit.

Adjoining prisms may have the same first surface (as shown in FIG. 7), or may have different first surfaces (as shown in FIG. 8).

As shown in FIG. 7, each prism may be formed by coupling a first prism unit 100a to a second prism unit 100b in the longitudinal direction. As shown, a second surface of the first prism unit 100a is coupled to a second surface of the second prism unit 100b. The prisms may be continuously arranged in the pitch direction, in which one end surface of each of the adjoining prisms has the same semicircular or triangular cross-section as that of the corresponding end surfaces of the other prisms in the longitudinal direction.

As shown in FIG. 8, each prism may be formed by coupling a first prism unit 100a to a second prism unit 100b in the longitudinal direction. As shown, a second surface of the first prism unit 100a is coupled to a second surface of the second prism unit 100b. The prisms may be continuously arranged in the pitch direction, in which one end surface of each of the adjoining prisms has a different cross-section than that of the corresponding end surface of the other (adjacent) prism in the longitudinal direction.

When the prisms (made of the prism units coupled to each other) are continuously arranged, the prisms may have a separation plane formed therebetween. Although the separation plane can reduce brightness, the separation plane serves to widen the viewing angle.

When the prisms are continuously arranged, the radius of curvature R may increase with an increase in the constant K. The viewing angle of the prism may increase with an increasing radius of curvature R of the side surface.

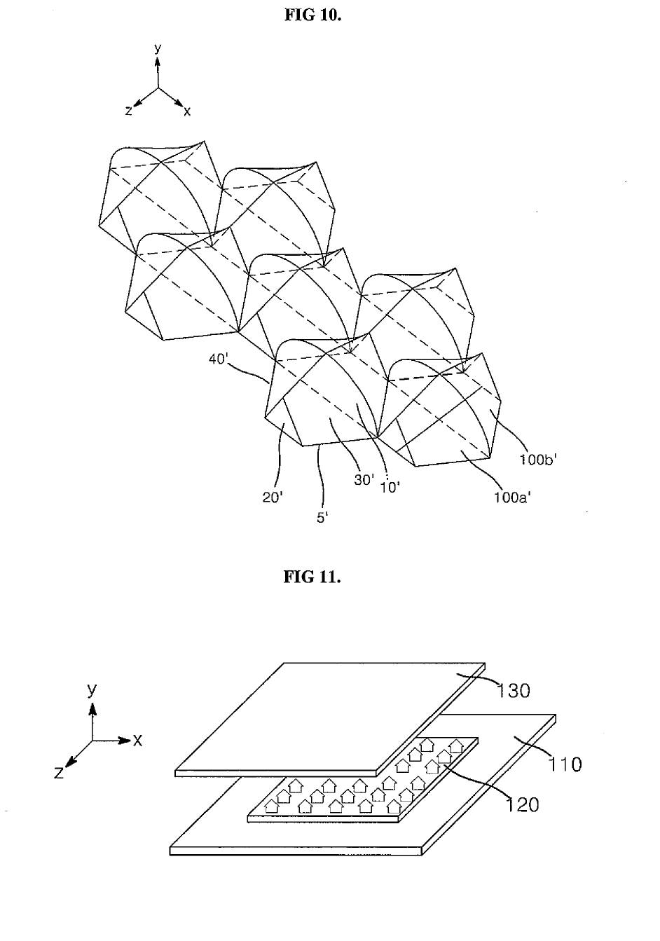

As shown in FIG. 10, in some embodiments, a plurality of prisms 100a′, 100b′ in which the prism units of FIG. 2 are coupled to each other is arranged in the longitudinal and pitch directions to form a honeycomb structure.

The prism may have a pitch W_{P} or W_{L} of about 1 μm to about 50,000 μm, for example about 1 μm to about 500 μm, and a height H of about 1 μm to about 50,000 μm, for example about 1 μm to about 500 μm. Within any one of these ranges, the optical sheet can exhibit improved brightness and viewing angle.

The prism may have a base angle α of about 30° to about 60°, an angle β facing the base angle α of about 30° to about 60°, and an apex angle γ of about 60° to about 120°. Within any one of these ranges, the optical sheet can exhibit improved brightness and viewing angle.

The optical sheet may further include a light collection section in which the prisms (formed by coupling a plurality of prism units to each other) are arranged on the rear surface and integrated with the base film.

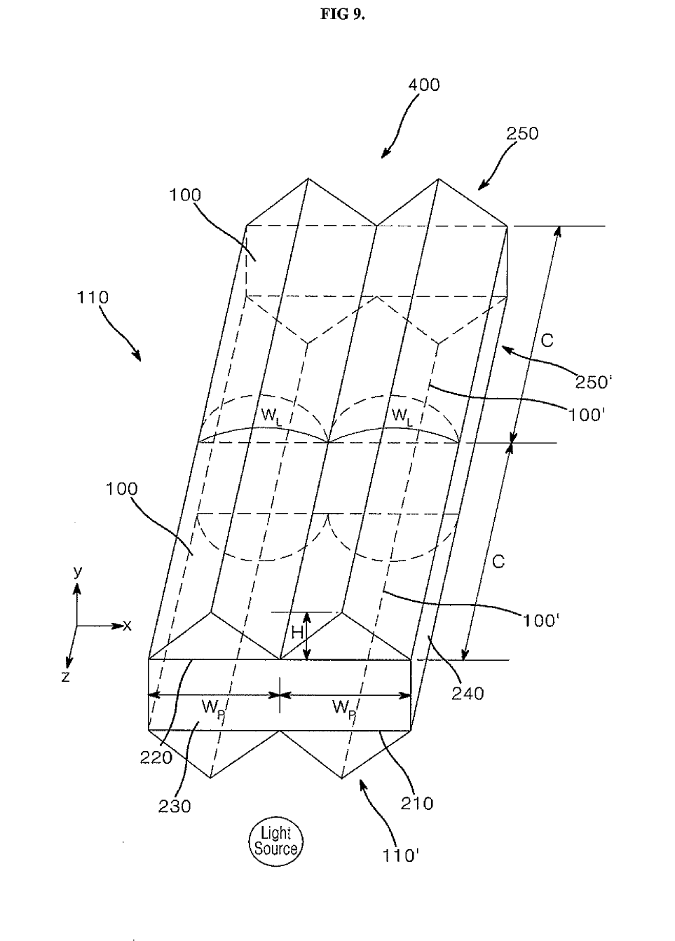

FIG. 9 is a perspective view of an optical sheet according to another embodiment of the present invention. Referring to FIG. 9, an optical sheet 400 according to an embodiment may include a base film 240, a first light collection section 250, and a second light collection section 250′. The base film 240 includes a rear surface 210, a front surface 220 facing the rear surface, and a side surface 230 connecting the rear and front surfaces to each other. The first light collection section 250 includes prisms 110 (formed by coupling a plurality of prism units 100 to each other) arranged on the front surface 220 of the base film and integrated with the base film. The second light collection section 250′ includes prisms 110′ (formed by coupling a plurality of prism units 100 to each other) arranged on the rear surface 210 of the base film and integrated with the base film.

When a longitudinal direction of the prism or prism unit on the front surface is defined as z1, and a longitudinal direction of the prism or prism unit on the rear surface is defined as z2, an angle between z1 and z2 may be about 0° to about 90°. Within this range, the optical sheet can obtain the effects of light collection and diffusion.

In accordance with another embodiment of the present invention, a backlight unit may include the optical sheet. As described above, the optical sheet collects light emitted from a light source and may be used as a prism sheet. In the backlight unit, the optical sheet may be disposed between a diffusive sheet and a protective sheet, but the present invention is not limited thereto. In addition to the optical sheet, the backlight unit may include a light source, a light guide plate, a reflective plate, a protective sheet, and the like, which are typically included in conventional backlight units.

In accordance with a further embodiment of the present invention, an optical apparatus may include the optical sheet or the backlight unit. The optical apparatus may include a display apparatus, such as a liquid crystal display, a large TV, or the like. In addition, the optical apparatus may include theater screens, screen filters, illumination films, a stand having a rear-mounted light source, and the like.

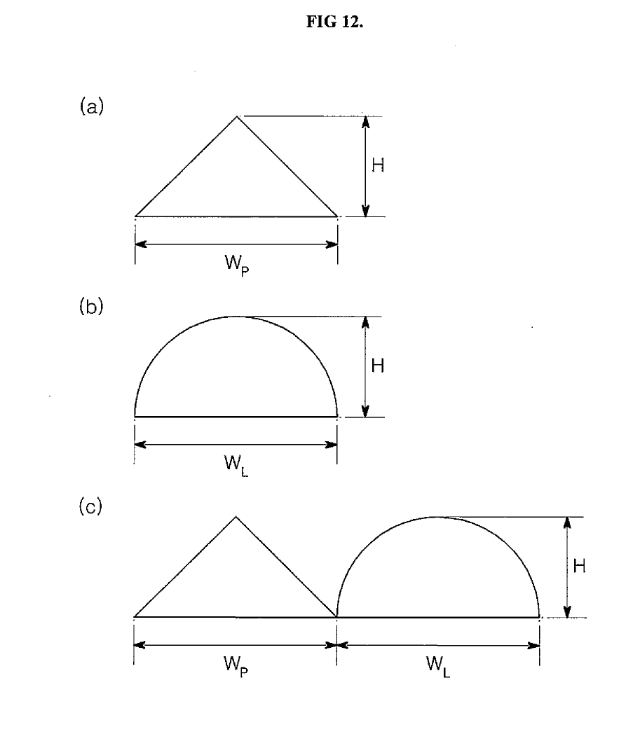

FIG. 11 shows a simulation model for the observation of brightness and viewing angle distribution according to embodiments of the present invention. The software used in the simulation was LightTools version 7.2 (ORA Co., Ltd., USA). To verify the optical properties of an optical sheet according to one embodiment of the invention, modeling was performed using the optical sheet, a light source, and a reflective plate. The light source 120 is a surface light source which uniformly emits light toward the overall surface of the optical sheet, and has a Lambertian exit angle distribution in which light is uniformly emitted at all angles. The arrows denote the emission direction of light. The reflective plate 110 exhibits mirror reflection properties and has a reflectivity of 98%. The optical sheet 130 was prepared from a resin having an index of refraction of 1.58, and a light refracting portion of the optical sheet has a modified shape. The light source and the reflective plate were secured as shown in FIG. 10 under the above conditions, and the optical sheet was placed on the light source as shown in FIG. 10 to evaluate brightness and the horizontal and vertical viewing angles.

The present invention will now be described with reference to the following examples. However, it should be noted that these examples are provided for illustration only and are not to be construed in any way as limiting the present invention.

### EXAMPLES 1 TO 3

In an optical sheet in which prism units were arranged as shown in FIG. 7, the length, pitch and height of the prisms were determined, and the results are listed in Table 1.

### EXAMPLES 4 TO 8

In an optical sheet in which prism units were arranged as shown in FIG. 8, the length, pitch and height of the prisms were determined, and the results are listed in Table 1.

### Comparative Example 1

Prisms having both opposite end surfaces with triangular cross-sections (as shown in FIG. 12a) were arranged in an optical sheet. The pitch (W_{P}) and height (H) of each prism were determined, and the results are listed in Table 1.

### Comparative Example 2

Prisms having both opposite end surfaces with semicircular cross-sections (as shown in FIG. 12b) were arranged in an optical sheet. The pitch (W_{L}) and height (H) of each prism were determined, and the results are listed in Table 1.

### Comparative Example 3

An optical sheet was prepared by alternately arranging prisms having both end surfaces with a triangular cross-section and prisms having both end surfaces with a semicircular cross-section (as shown in FIG. 12c). The pitch (W_{P},W_{L}) and height (H) of each prism were determined, and the result are listed in Table 1.

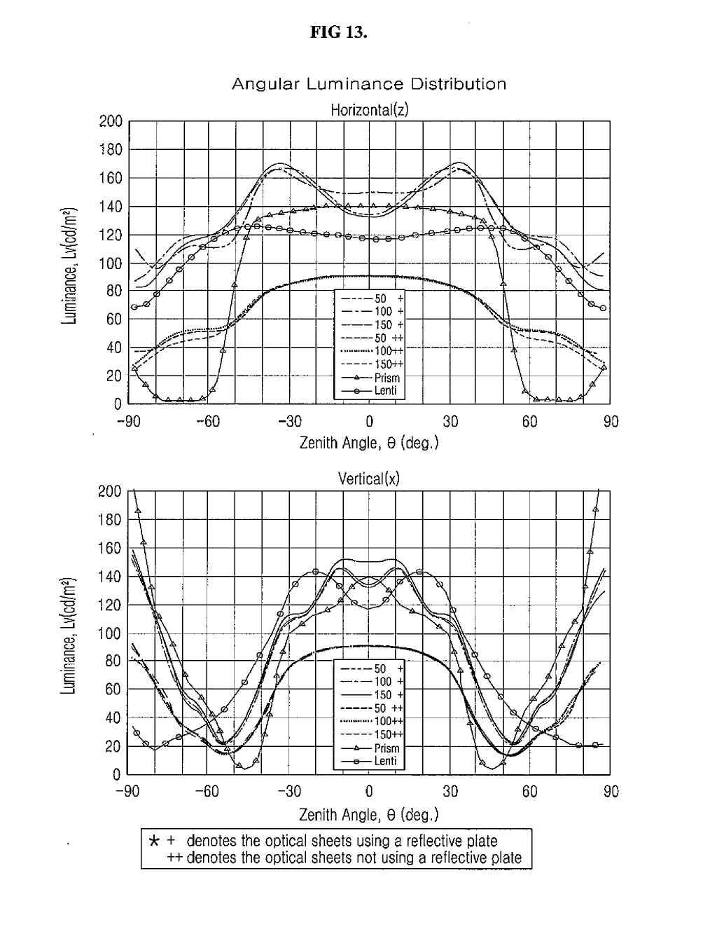

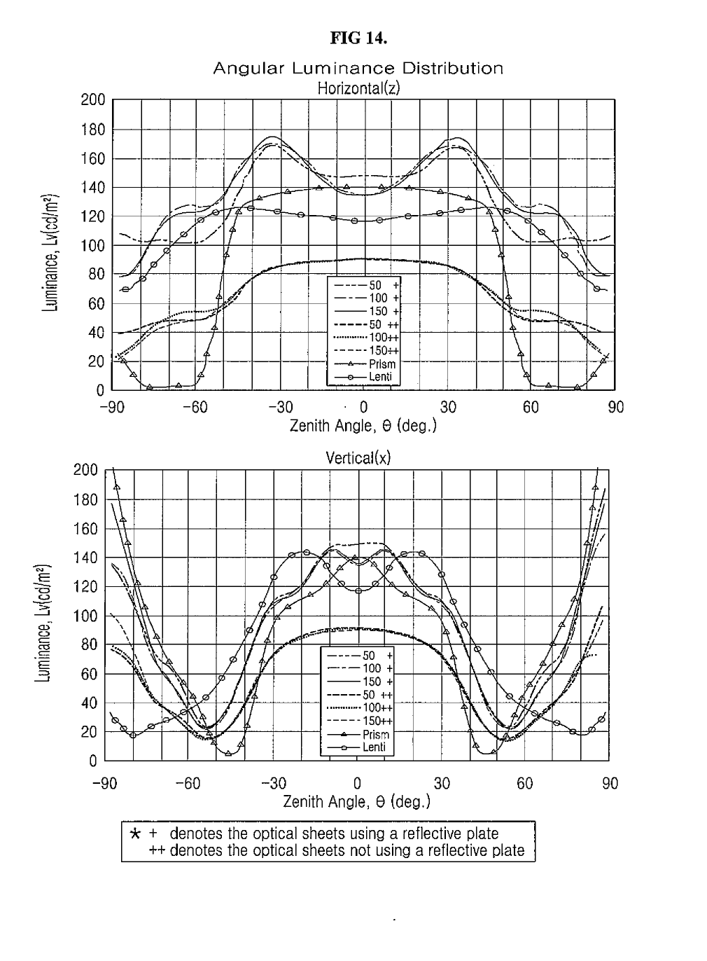

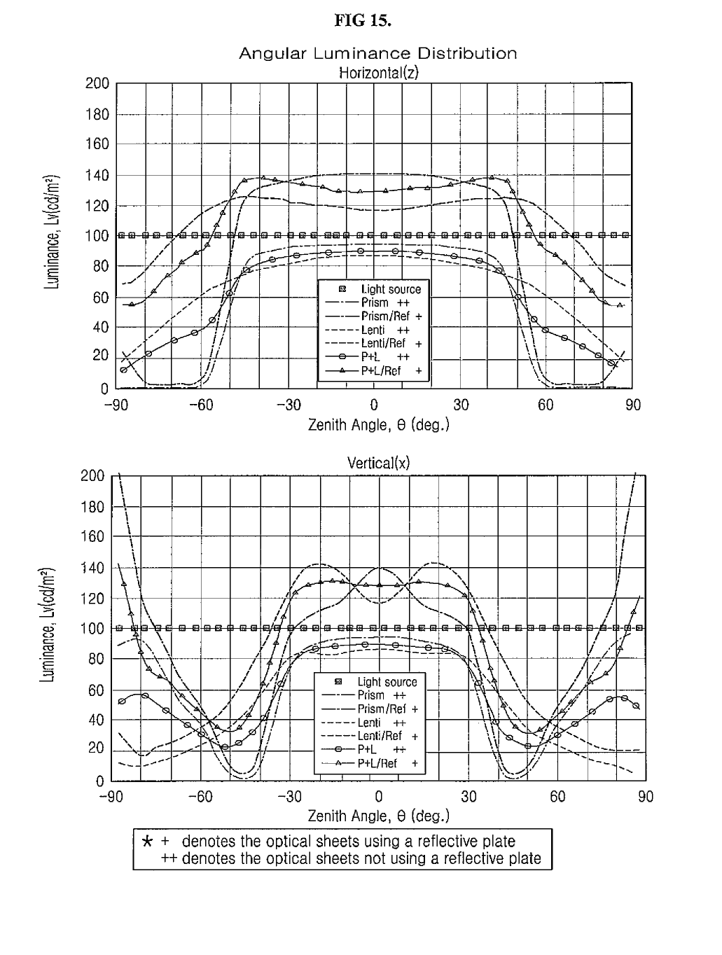

Simulations were performed on the optical sheets of the Examples and Comparative Examples under the above-described simulation conditions. Measurement were taken for brightness and horizontal and vertical viewing angles, and the measurement results are shown in Table 1 and FIGS. 13 to 15.

TABLE 1

| | | | | Brightness | Hori- | Vertical |
|---|---|---|---|---|---|---|
| | Length | | | (% rela- | zontal | View- |
| | of | | | tive to | Viewing | ing |
| | Prism | Pitch | Height | light | angle | angle |
| | (μm) | (μm) | (μm) | source) | (°) | (°) |
| Example 1 | 50 | 50 | 25 | 149.5 | — | 77.1 |
| Example 2 | 100 | 50 | 25 | 133.1 | — | 79.6 |
| Example 3 | 150 | 50 | 25 | 132.3 | — | 79.8 |
| Example 4 | 50 | 50 | 25 | 147.9 | — | 77.2 |
| Example 5 | 100 | 50 | 25 | 133.9 | — | 79.2 |
| Example 6 | 150 | 50 | 25 | 134.8 | — | 79.5 |
| Example 7 | 50 | 25 | 12.5 | 144.6 | — | 76.9 |
| Example 8 | 50 | 50 | 25 | 147.9 | — | 77.6 |
| Comparative | — | 50 | 25 | 139.6 | 103.2 | 68.1 |
| Example 1 | | | | | | |
| Comparative | — | 50 | 25 | 116.2 | — | 96.4 |
| Example 2 | | | | | | |
| Comparative | — | 50 | 25 | 128.0 | 152.8 | 77.6 |
| Example 3 | | | | | | |

As shown in Table 1, the optical sheets according to embodiments of the invention exhibited improved brightness and wider viewing angles than the optical sheet of Comparative Example 1 (including only a conventional prism). Also, the optical sheets according to embodiments of the invention exhibited significantly improved brightness as compared with the optical sheet of Comparative Example 2 (including a prism having a semicircular cross-section). Additionally, the optical sheets according to embodiments of the invention exhibited improved brightness and viewing angles as compared with the optical sheet of Comparative Example 3 (in which prisms having both end surfaces with triangular cross-sections and prisms having both end surfaces with semicircular cross-sections were alternately arranged).

Although some exemplary embodiments have been disclosed herein, it should be understood by those of ordinary skill in the art that the described embodiments are provided by way of illustration only, and that various modifications, changes, and alterations can be made to the described embodiments without departing from the spirit and scope of the invention, as defined by the accompanying claims and their equivalents.

What is claimed is:

1. An optical sheet comprising:
a base film comprising a rear surface for receiving incident light, a front surface facing the rear surface for emitting the light, and a side surface connecting the rear and front surfaces to each other; and
a first light collection section comprising prisms, each prism comprising a plurality of prism units coupled to each other, the prisms being arranged on the front surface of the base film and integrated with the base film,
wherein each prism unit includes a first end surface and a second end surface, the first and second end surfaces being opposite one another in a longitudinal direction of the prism unit, and one of the first or second end surfaces has a semicircular shape.

2. The optical sheet according to claim 1, wherein the first end surface has a triangular shape, and the second end surface has a semicircular shape.

3. The optical sheet according to claim 2, wherein each prism unit has a cross-section that gradually changes from a triangular shape to a semicircular shape with increasing longitudinal distance from the first end surface to the second end surface.

4. The optical sheet according to claim 2, wherein each prism unit has a constant pitch, height, and apex angle in a longitudinal direction of the prism unit.

5. The optical sheet according to claim 2, wherein at least one of a pitch, height, and apex angle of each prism unit varies in a longitudinal direction of the prism unit.

6. The optical sheet according to claim 5, wherein each prism unit has an increasing or decreasing pitch, height, or apex angle in the longitudinal direction of the prism unit.

7. The optical sheet according to claim 1, wherein the side surface has a radius of curvature R of about 1 μm to about 100,000 μm, wherein the radius of curvature R is represented by Equation 1:
$$R = P \times {z}^{2} + \frac{( K - P )}{{C}^{3}} , \qquad Equation 1$$
wherein P is a value of half a pitch (W_{P} or W_{L}) of the first or second end surface;
z is a value of a z-component of coordinates x, y and z which represent the pitch, height and longitudinal direction of the prism unit;
K is a constant with a value of 100 to 10,000; and
C is a length of the prism.

8. The optical sheet according to claim 1, wherein the prism comprises at least two of the prism units coupled to each other in the longitudinal direction of the prism units.

9. The optical sheet according to claim 8, wherein the first end surfaces of the at least two of the prism units are coupled to each other, or the second end surfaces of the at least two of the prism units are coupled to each other.

10. The optical sheet according to claim 8, wherein the prisms are continuously arranged in at least one of a pitch direction or a longitudinal direction of the prism units.

11. The optical sheet according to claim 8, wherein the prisms are arranged in a honeycomb structure.

12. The optical sheet according to claim 10, wherein the prisms have an increasing pitch with increasing distance from a light source.

13. The optical sheet according to claim 10, wherein the prism units have an increasing radius of curvature R as represented by Equation 1 with increasing distance from a light source:
$$R = P \times {z}^{2} + \frac{( K - P )}{{C}^{3}} \qquad Equation 1$$
wherein P is a value of half a pitch (W_{P} or W_{L}) of the first or second end surface;
z is a value of a z-component of coordinates x, y and z which represent the pitch, height and longitudinal direction of the prism unit;
K is a constant with a value of 100 to 10,000; and
C is a length of the prism.

14. The optical sheet according to claim 1, wherein the prism units have a height of about 1 μm to about 50,000 μm.

15. The optical sheet according to claim 1, wherein the prism units have a pitch of about 1 μm to about 50,000 μm.

16. The optical sheet according to claim 1, wherein the prism units have a length of about 1 μm to about 500,000 μm.

17. The optical sheet according to claim 1, wherein the prism units have an apex angle of about 60° to about 120°.

18. The optical sheet according to claim 1, further comprising:
a second light collection section comprising second prisms, each second prism comprising a plurality of second prism units coupled to each other, the second prisms being arranged on the rear surface of the base film and integrated with the base film,
wherein each second prism unit includes a first end surface and a second end surface, the first and second end surfaces being opposite one another in a longitudinal direction of the second prism unit, and one of the first or second end surfaces has a semicircular shape.

19. The optical sheet according to claim 18, wherein the first end surface of the second prism unit has a triangular shape, and the second end surface of the second prism unit has a semicircular shape.

20. The optical sheet according to claim 18, wherein an angle between a longitudinal direction of the prisms on the front surface (z1) and a longitudinal direction of the second prisms on the rear surface (z2) is about 0° to about 90°.

21. A backlight unit comprising the optical sheet according to claim 1.

22. An optical apparatus comprising the optical sheet according to claim 1.
